(19) United States
(12) Patent Application Publication
(10) Pub. No.: US 2026/0145524 A1
(43) Pub. Date: May 28, 2026

(54) METHOD, SYSTEM, AND COMPUTER PROGRAM FOR PROVIDING AUGMENTED CONTENT FOR TRANSPARENT DISPLAY BASED ON THE GAZE OF A MOBILITY OCCUPANT

(71) Applicant: Korea Photonics Technology Institute, Gwangju (KR)

(72) Inventors: Hoe Min KIM, Gwangju (KR); Sung Kuk CHUN, Gwangju (KR); Seon Kyu YOON, Gwangju (KR); Min Kyu PARK, Gwangju (KR); Un Yong KIM, Gwangju (KR)

(73) Assignee: Korea Photonics Technology Institute, Gwangju (KR)

(21) Appl. No.: 19/385,283

(22) Filed: Nov. 11, 2025

(30) Foreign Application Priority Data
Nov. 26, 2024 (KR) 10-2024-0171415
Oct. 17, 2025 (KR) 10-2025-0150829

(51) Int. Cl. B60K 35/28; B60K 35/10; B60K 35/233; G06V 20/59; G06V 40/16; G06V 40/18

(52) U.S. Cl. CPC B60K 35/28; B60K 35/10; B60K 35/233; G06V 20/59; G06V 40/161; G06V 40/18; B60K 2360/149; B60K 2360/177; B60K 2360/27; B60K 2360/785

(57) ABSTRACT

A method for providing augmented content for a transparent display based on the gaze of a mobility occupant includes acquiring an internal object image, which includes one or more mobility occupants, using a camera module disposed in a mobility vehicle having a transparent display window; detecting face regions having a bounding box set based on the internal object image, and setting a main user by designating the face region whose bounding box has a size equal to or greater than a preset size as the main face object; detecting face location information and gaze information centered on the main face object, and detecting candidate objects to be augmented within the user's field of view directed toward the exterior of the mobility vehicle based on the detected gaze information; selecting at least one candidate object as an augmentation target and augmenting and displaying augmentation target content.

### CROSS-REFERENCE TO RELATED APPLICATIONS

This application claims priority to Korean Patent Application No. 10-2024-0171415 filed on Nov. 26, 2024, and Korean Patent Application No. 10-2025-0150829 filed on Oct. 17, 2025, the entire contents of which are herein incorporated by reference.

### BACKGROUND

### 1. Technical Field

These patents are the results of research that was carried out by the support (a unique project number: 2370000322, a detailed project number: 00441262, a project name: Development of UX Service Technology Based on New Technology Convergence Content for Enjoying Cultural Content by Occupants in Mobility) of the Korea Creative Content Agency (KOCCA) by the finances of the government of the Republic of Korea (Ministry of Culture, Sports and Tourism) in 2025.

The present invention relates to a method and a system for providing augmented content for a transparent display based on the gaze of a mobility occupant (or mobility vehicle occupant), and a computer program for executing the same, which can provide content that targets the object and background the occupant is looking at as an augmentation target by tracking the occupant's gaze.

### 2. Related Art

The content described in this section merely provides background information for the present embodiment and does not constitute prior art.

The mobility industry is divided into autonomous vehicles, drones, micro-mobility, and electric vehicles in terms of hardware, and can be categorized into various mobility services in terms of service, such as ride-hailing, car-sharing, ride-sharing, smart logistics, and smart cooperative intelligent transportation systems. This mobility industry is evolving into mobility services in the form of unmanned vehicles carrying multiple passengers. In such unmanned vehicle-type mobility, transparent displays are installed on the front, rear, and side windows, and services based on the development of technologies like 5G communication, Internet of Things (IoT), AR (Augmented Reality), or VR (Virtual Reality) are being applied.

However, conventional technologies for displaying AR objects on the transparent displays of mobility vehicles have problems such as mismatches between the AR objects augmented on the transparent display and the real-world objects outside when multiple passengers are in the vehicle, or a significant drop in the readability or clarity of the AR content when it is provided without considering the passengers' gaze.

Furthermore, various scenarios can arise, such as passengers looking forward, passengers looking sideways, passengers looking backward, seated passengers, or standing passengers. In these cases, it can be difficult to match the AR object displayed on the transparent display with the actual object or background for each passenger's position. Additionally, the content each passenger expects or the object they are interested in looking at may differ.

Therefore, while there is a need for a display that all passengers within the mobility vehicle can share, it is also necessary to provide content where the AR object aligns with the actual object being viewed by the specific passenger, considering their gaze relative to each transparent display. Consequently, there is a current need for content control technology that allows passengers in the mobility vehicle to comfortably view the external scenery and the various content linked to it through the transparent display, taking into account factors like vehicle vibration and travel speed.

### SUMMARY

One objective of an embodiment of the present invention is to provide a method and a system for providing augmented content for a transparent display based on the gaze of a mobility occupant, which can provide augmented content in front of the occupant's gaze by tracking the occupant's gaze and setting the object and background within the field of view (FOV) box (or gaze box) the occupant is looking at as the augmentation target.

According to one aspect of the present invention, there is provided a method for providing augmented content for a transparent display based on the gaze of a mobility occupant, performed by a computing apparatus including at least one processor, the method comprising: an image acquisition step of acquiring an internal object image including one or more mobility occupants using a camera module disposed in a mobility vehicle having a transparent display window; a user setting step of detecting face regions with set bounding boxes based on the internal object image, and setting a main user by designating the face region having a bounding box size greater than or equal to a preset size as the main face object; a candidate object detection step of detecting face location information and gaze information centered on the main face object, and detecting candidate objects to be augmented within the user's field of view (FOV) angle directed outside the mobility vehicle based on the detected gaze information; an augmentation target selection step of selecting at least one candidate object as an augmentation target that satisfies one or more conditions among the candidate objects, where the conditions include: a field-of-view (FOV) angle condition for detecting an object present within the user's FOV angle based on the gaze information; an apparent size condition for detecting an object larger than a preset threshold based on the distance between the face location information and each candidate object; and an angular velocity condition for detecting an object moving at or below a preset reference angular velocity using the face location information and the speed of the mobility vehicle; and a content augmentation step of augmenting and displaying augmentation target content including the selected augmentation target object on the transparent display window corresponding to the face location information.

Alternatively, the candidate object detection step comprises setting landmarks on the main face object and tracking gaze information, including a gaze vector and a field of view (FOV) angle for the main face object, based on the set landmarks.

Alternatively, the field-of-view condition may comprise detecting a gaze vector (G) and an object direction vector (Vo) of each candidate object, and detecting an object in which an angle (φᵢ) between the detected gaze vector and the object direction vector is less than ½ of a maximum field of view (θ_{FOV}) based on the following formula.

Alternatively, the apparent size condition may comprise detecting an object larger than a preset height threshold (Hₜₕ) or a preset area threshold (Wₜₕ) based on the following formula, which utilizes an actual object height (Hᵢ) of each candidate object, an actual object area (Wᵢ) of each candidate object, and a distance (Dᵢ) between the face location information and the candidate object.

Alternatively, the augmentation target selection step may comprise displaying helper objects of different sizes on the transparent display window, and when one of the helper objects is selected via user input, setting the height threshold or the area threshold based on the size of the selected helper object.

Alternatively, the angular velocity condition may comprise detecting an object in which an angular velocity (ωᵢ), calculated based on the following formula utilizing a speed of the mobility vehicle (Sᵥ), a distance (Dᵢ) between the face location information and the candidate object, and an angle (θᵢ) between the mobility vehicle's direction of travel and the object, is less than a preset threshold (ωₜₕ).

Alternatively, the augmentation target selection step comprises calculating a field-of-view (FOV) angle score, an apparent size score, and an angular velocity score using the FOV angle condition, the apparent size condition, and the angular velocity condition, respectively; synthesizing the calculated FOV angle score, apparent size score, and angular velocity score to calculate an augmentation suitability score; and selecting objects whose calculated augmentation suitability score is greater than or equal to a preset threshold as augmentation targets.

Alternatively, the augmentation target selection step further comprises an operation in which the augmentation suitability score (Score_{A}) for each candidate object (Oi) is calculated as a weighted product of the field of view (FOV) angle score (Score_{FOV}), the apparent size score (Score_{Size}), and the angular velocity score (Score_{ω}) according to the following formula, where w₁, w₂ and w₃ are the respective weights for the FOV angle score, the apparent size score, and the angular velocity score, and the sum of each weight is 1.

Alternatively, the content augmentation step comprises displaying the augmentation target content, wherein a size of the augmentation target content is warped inversely proportional to a cosine value of an angle formed between the gaze vector within the gaze information and a normal vector of the transparent display window, considering a perspective view.

According to one aspect of the present invention, there is provided a method for providing augmented content for a transparent display based on the gaze of a mobility occupant, performed by a computing apparatus including at least one processor, the method comprising: an image acquisition step of acquiring an internal object image including one or more mobility occupants using a camera module disposed in a mobility vehicle having a transparent display window; a user setting step of detecting face regions with set bounding boxes based on the internal object image, and setting a main user by designating the face region having a bounding box size greater than or equal to a preset size as the main face object; a candidate object detection step of detecting face location information and gaze information centered on the main face object, and detecting candidate objects to be augmented within the user's field of view (FOV) angle directed outside the mobility vehicle based on the detected gaze information; an augmentation target selection step of selecting at least one candidate object as an augmentation target that satisfies one or more conditions among the candidate objects, where the conditions include: a field of view (FOV) angle condition for detecting an object present within the user's FOV angle based on the gaze information; an apparent size condition for detecting an object larger than a preset threshold based on the distance between the face location information and each candidate object; and an angular velocity condition for detecting an object moving at or below a preset reference angular velocity using the face location information and the speed of the mobility vehicle; a content augmentation step of augmenting and displaying augmentation target content including the selected augmentation target object on the transparent display window corresponding to the face location information; a vibration detection step in which one or more markers are disposed in a preset area of the transparent display window, and a phase change in the face location information is detected based on the marker position information; and a content compensation step of reducing the transparency of the augmentation target content or moving the augmentation target content toward the face direction based on the face location information, if the face location information fluctuates by more than a preset threshold based on the marker position information.

Alternatively, the content compensation step comprises omitting the content compensation process for the augmentation target content if the face location information fluctuates within a preset threshold based on the marker position information.

According to one aspect of the present invention, there is provided a computing apparatus for providing content for a transparent display based on the gaze of a mobility occupant, the computing apparatus comprising: a processor including at least one core; and memory including program codes executable by the processor; wherein the processor, upon executing the program codes, is configured to: acquire an internal object image including one or more mobility occupants using a camera module disposed in a mobility vehicle having a transparent display window; detect face regions with set bounding boxes based on the internal object image, and set a main user by designating the face region having a bounding box size greater than or equal to a preset size as the main face object; detect face location information and gaze information centered on the main face object, and detect candidate objects to be augmented within the user's field of view (FOV) angle directed outside the mobility vehicle based on the detected gaze information; select at least one candidate object as an augmentation target that satisfies one or more conditions among the candidate objects, where the conditions include: a field of view (FOV) angle condition for detecting an object present within the user's FOV angle based on the gaze information; an apparent size condition for detecting an object larger than a preset threshold based on the distance between the face location information and each candidate object; and an angular velocity condition for detecting an object moving at or below a preset reference angular velocity using the face location information and the speed of the mobility vehicle; and
augment and display augmentation target content including the selected augmentation target object on the transparent display window corresponding to the face location information.

According to one aspect of the present invention, there is provided a computer program stored on a computer-readable storage medium, wherein when the computer program is executed on one or more processors, it performs operations for providing content for a transparent display based on the gaze of a mobility occupant, the operations comprising: an image acquisition operation of acquiring an internal object image including one or more mobility occupants using a camera module disposed in a mobility vehicle having a transparent display window; a user setting operation of detecting face regions with set bounding boxes based on the internal object image, and setting a main user by designating the face region having a bounding box size greater than or equal to a preset size as the main face object; a candidate object detection operation of detecting face location information and gaze information centered on the main face object, and detecting candidate objects to be augmented within the user's field of view (FOV) angle directed outside the mobility vehicle based on the detected gaze information; an augmentation target selection operation of selecting at least one candidate object as an augmentation target that satisfies one or more conditions among the candidate objects, where the conditions include: a field of view (FOV) angle condition for detecting an object present within the user's FOV angle based on the gaze information; an apparent size condition for detecting an object larger than a preset threshold based on the distance between the face location information and each candidate object; and an angular velocity condition for detecting an object moving at or below a preset reference angular velocity using the face location information and the speed of the mobility vehicle; and a content augmentation operation of augmenting and displaying augmentation target content including the selected augmentation target object on the transparent display window corresponding to the face location information.

As described above, the present invention has the effect of delivering content to the user more stably and clearly based on the occupant's gaze information by augmenting only the content the occupant is interested in viewing and displaying it on the transparent display window. Furthermore, by providing content with compensated position that reflects vehicle vibration, the present invention has the effect of reducing dizziness or vertigo for the occupant viewing the augmented content.

### BRIEF DESCRIPTION OF THE DRAWINGS

FIG. 1 is a diagram briefly illustrating a mobility vehicle according to an embodiment of the present invention.

FIG. 2 is a diagram illustrating the configuration of a system for executing a method of providing augmented content for a transparent display based on the gaze of a mobility occupant according to an embodiment of the present invention.

FIG. 3 is a block diagram of a computing apparatus according to an embodiment of the present invention.

FIG. 4 is a block diagram for specifically illustrating a processor according to an embodiment of the present invention.

FIG. 5 is a flowchart illustrating the process of selecting a main user in a method of providing augmented content for a transparent display based on the gaze of a mobility occupant according to an embodiment of the present invention.

FIG. 6 is a flowchart illustrating a method of providing augmented content for a transparent display based on the gaze of a mobility occupant according to an embodiment of the present invention.

FIG. 7 is an exemplary diagram illustrating a gaze box detection process according to an embodiment of the present invention.

FIG. 8 is a diagram illustrating the process of dividing a detected gaze box into a plurality of layers according to an embodiment of the present invention.

FIG. 9 is a diagram illustrating the process of selecting an augmentation target according to an embodiment of the present invention.

FIG. 10 is an exemplary diagram illustrating a user command input process for selecting an augmentation target on a transparent display window according to an embodiment of the present invention.

FIG. 11 is an exemplary diagram illustrating a gaze-focused content detection process according to an embodiment of the present invention.

FIG. 12 is an exemplary diagram illustrating a process of displaying augmentation target content based on distance-based priority information according to an embodiment of the present invention.

FIG. 13 is an exemplary diagram illustrating a process of displaying augmentation target content based on gaze-based priority information according to an embodiment of the present invention.

FIG. 14 is an exemplary diagram illustrating a process of displaying a virtual object corresponding to an augmentation target by overlapping it according to an embodiment of the present invention.

FIG. 15 is a flowchart illustrating the process of optimizing content considering vehicle vibration in a method of providing augmented content for a transparent display based on the gaze of a mobility occupant according to an embodiment of the present invention.

FIG. 16 is an exemplary diagram illustrating the process of detecting changes in movement between a marker and a face object according to an embodiment of the present invention.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used only to describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part or a combination of them, and should be understood that it does not exclude the existence or possible addition of one or more other characteristics, numbers, steps, operations, components, parts, or combinations of them in advance.

The term “obtain” used in the present disclosure may be understood as meaning that data are generated in an on-device form in addition to receiving data over wired and wireless communication networks with an outside device or system.

The term “module” or “unit” used in the present disclosure may be understood as a term that denotes an independent function unit that processes computing resources like a computer-related entity, firmware, software or a part thereof, hardware or a part thereof, and a combination of software and hardware. In this case, the “module” or “unit” may be a unit including a single component, and may be a unit that is expressed as a combination or set of a plurality of components. For example, the “module” or “unit” as a narrow concept may be denoted as a hardware component of a computing apparatus or a set thereof, an application program that performs a specific function of software, a procedure that is implemented through software execution, or an instruction set for program execution. Furthermore, the “module” or “unit” as a wide concept may be denoted as a computing apparatus itself that constitutes a system or an application that is executed in a computing apparatus. In this case, the concept is merely an example, and the concept of the “module” or “unit” may be variously defined in a category which may be understood by those skilled in the art based on the contents of the present disclosure.

All terms used herein, including technical terms or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

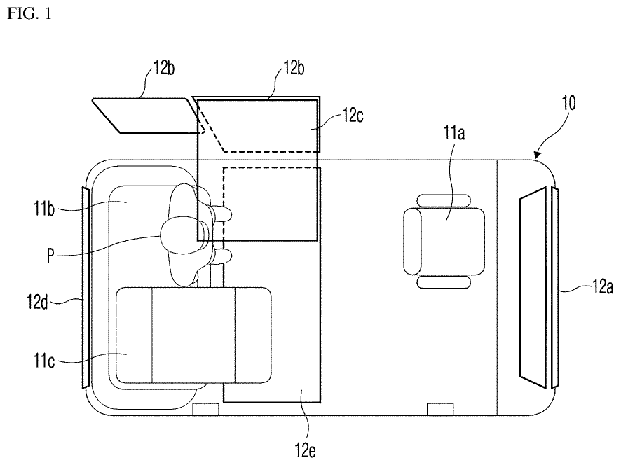

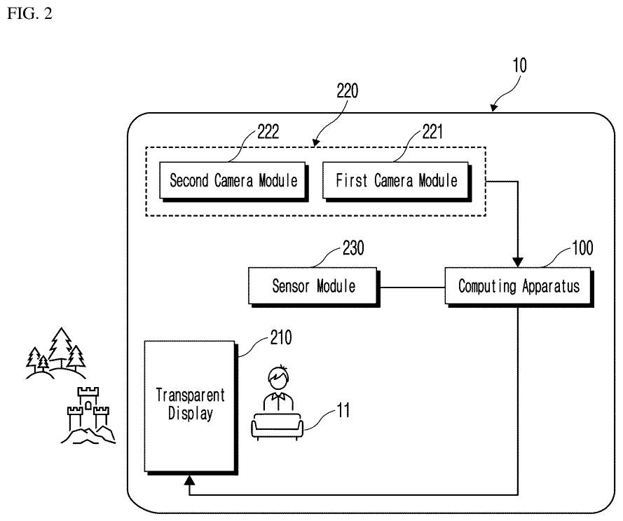

FIG. 1 is a diagram briefly illustrating a mobility vehicle according to an embodiment of the present invention, and FIG. 2 is a diagram illustrating the configuration of a system for executing a method of providing augmented content for a transparent display based on the gaze of a mobility occupant according to an embodiment of the present invention.

Referring to FIGS. 1 and 2, the mobility vehicle 10 is equipped with a front window 12a, a side window 12b, a ceiling window 12c, a rear window 12d, or a floor window 12e. A transparent display window 210 may be disposed on the front, side, or ceiling among these windows, and a camera module 220 may be disposed corresponding to each seat 11a, 11b, and 11c provided inside the vehicle. Furthermore, the mobility vehicle 10 may include a sensor module 230, such as a GPS, an Inertial Measurement Unit (IMU), a radar sensor, and a Light Detection and Ranging (LIDAR) sensor, disposed inside or outside the vehicle. The sensor module 230 may further include a distance sensor using infrared rays, ultrasonic waves, or the like, which is disposed on an inner ceiling surface corresponding to the seats provided inside the vehicle, to measure the user's position. This distance sensor can measure the vertical distance to the user located in the seat.

Here, the mobility vehicle 10 may be an autonomous vehicle capable of operating independently without user manipulation, but it may also be an internal combustion engine vehicle equipped with an engine, a hybrid vehicle equipped with an engine and an electric motor, an electric vehicle equipped with an electric motor, a hydrogen fuel cell vehicle equipped with a fuel cell, and the like.

Each window of the mobility vehicle 10, when a transparent display is applied, can be referred to as a smart window, and the smart window can provide time information, weather information, navigation information, tour information, and the like, along with the exterior view.

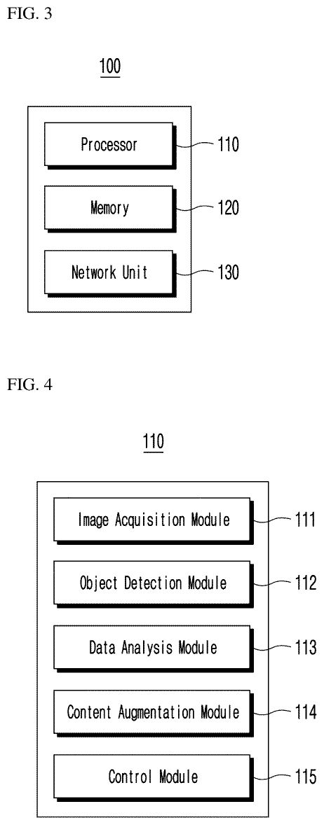

FIG. 3 is a block diagram of a computing apparatus according to an embodiment of the present invention, and FIG. 4 is a block diagram for specifically illustrating a processor according to an embodiment of the present invention.

The computing apparatus 100 according to an embodiment of the present disclosure may be a hardware device or a part of a hardware device that performs comprehensive processing and calculation of data, or may be a software-based computing environment connected through a communication network. For example, the computing apparatus 100 may be a server that is the subject of performing intensive data processing functions and sharing resources, or it may be a client that shares resources through interaction with the server. Furthermore, the computing apparatus 100 may be a cloud system in which a plurality of servers and clients interact to comprehensively process data. Since the above description is only one example related to the type of the computing apparatus 100, the type of the computing apparatus 100 can be variously configured within a range understandable by those skilled in the art based on the content of the present disclosure.

Referring to FIG. 3, the computing apparatus 100 according to an embodiment of the present disclosure may include a processor 110, a memory 120, and a network unit 130. However, since FIG. 3 is only an example, the computing apparatus 100 may include other components for implementing a computing environment. Furthermore, only some of the disclosed components may be included in the computing apparatus 100.

The processor 110 according to an embodiment of the present disclosure can be understood as a constituent unit including hardware and/or software for performing computing operations. For example, the processor 110 may read a computer program and perform data processing for machine learning. The processor 110 can handle operational processes such as processing input data for machine learning, feature extraction for machine learning, and error calculation based on backpropagation. The processor 110 for performing such data processing may include a Central Processing Unit (CPU), a General Purpose Graphics Processing Unit (GPGPU), a Tensor Processing Unit (TPU), an Application Specific Integrated Circuit (ASIC), or a Field Programmable Gate Array (FPGA). Since the type of the processor 110 described above is only an example, the type of the processor 110 can be variously configured within a range understandable by those skilled in the art based on the content of the present disclosure.

As shown in FIG. 4, the processor 110 includes, but is not limited to, an image acquisition module 111, an object detection module 112, a data analysis module 113, a content augmentation module 114, and a control module 115.

The image acquisition module 111 obtains images of the interior or exterior of the vehicle from at least one camera module 220 disposed inside or outside the mobility vehicle 10.

The object detection module 112 may detect a face object in the interior image of the vehicle obtained from the camera module 220, or detect an augmentation target object that is subject to augmentation in the exterior image of the vehicle. In this case, the object detection module 112 is an object detection algorithm that finds designated object instances in an image, and it can detect a main object and mark and distinguish the detected object with a Bounding Box around it. For this purpose, the object detection module 112 may use pre-trained artificial intelligence models such as R-CNN, OverFeat, SPPNet, Fast R-CNN, Faster R-CNN, and YOLO (You Only Look Once). Specifically, the object detection module 112 may train an artificial intelligence model using various datasets, such as the FDDB (Face Detection Data Set and Benchmark) dataset, datasets provided by Roboflow, ImageNet, and the IMDB-Wiki dataset, for face recognition. Furthermore, the processor 110 may train the model to be optimally fit through fine-tuning of various deep learning-based object detection algorithms or models.

In addition to the examples described above, the type of data for training the artificial intelligence model and the output of the artificial intelligence model can be variously configured within a range understandable by those skilled in the art based on the content of the present disclosure. Furthermore, at least one artificial intelligence model can be used, and a plurality of artificial intelligence models may be integrated into a single network, may partially share some networks, or may be implemented as separate independent networks.

The data analysis module 113 can analyze an augmentation target to be displayed on the transparent display window, or additional content associated with the augmentation target, based on the user's gaze information, using sensor information obtained from the sensor module 230 and objects detected by the object detection module 112. For example, the data analysis module 113 can analyze the current travel route of the mobility vehicle 10 based on map information and vehicle location information, and major tourist attraction information or building information centered around the travel route. Accordingly, the data analysis module 113 can analyze what augmentation target content or gaze-focused content (or fixation content) the user is interested in viewing, based on gaze information including the user's viewing range (or field of view), gaze vector, and fixation time.

The content augmentation module 114 can augment and display augmentation target content or gaze-focused content on the transparent display window 210 corresponding to the user's seat. The content augmentation module 114 obtains GPS-based mobility vehicle location information and user seat information for the seat where the camera module 220 is disposed, extracts map information matching the acquired mobility vehicle location information and user seat information, and then can augment the selected augmentation target and additional content associated with the augmentation target by mapping face location information and gaze information to the map information.

The content augmentation module 114 can prevent the shape of the augmentation target content perceived by the main user from being distorted by performing size warping, inversely proportional to the cosine value of the angle formed by the gaze vector and the normal vector of the transparent display window 210, in consideration of the perspective view.

The control module 115 performs overall control operations for each module, thereby enabling the system to track the gaze of the mobility vehicle occupant and selectively augment only the main objects among the objects in the exterior view of the mobility vehicle as augmentation targets, thus reducing the system's rendering load, decreasing occupant fatigue, and augmenting the augmentation target content stably and clearly on the transparent display window 210.

The aforementioned modules are merely an embodiment for explaining the present invention and can be implemented in various variations without limitation thereto. Furthermore, the aforementioned modules are stored in a memory as a computer-readable recording medium controllable by the processor 110. In addition, at least a portion of the aforementioned modules may be implemented as software, firmware, hardware, or a combination of at least two of these, and may include a module, program, routine, instruction set, or process for performing one or more functions.

Referring again to FIG. 3, the memory 120 according to an embodiment of the present disclosure can be understood as a constituent unit including hardware and/or software for storing and managing data processed in the computing apparatus 100. That is, the memory 120 may store any form of data generated or determined by the processor 110 and any form of data received by the network unit 130. For example, the memory 120 may include at least one type of storage medium among a flash memory type, a hard disk type, a multimedia card micro type, a card type memory, RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, and optical disk. Furthermore, the memory 120 may include a database system that controls and manages data in a predetermined system. Since the type of the memory 120 described above is only an example, the type of the memory 120 can be variously configured within a range understandable by those skilled in the art based on the content of the present disclosure.

The memory 120 can structure, organize, and manage data necessary for the processor 110 to perform operations, combinations of data, and program code executable by the processor 110. For example, the memory 120 can store various types of data via the network unit 130, which will be described later. The memory 120 may store program code that operates one or more artificial intelligence learning models to perform learning, program code that operates the artificial intelligence learning model to receive data and perform inference according to the purpose of use of the computing apparatus 100, and processed data generated as the program code is executed.

The network unit 130 according to an embodiment of the present disclosure can be understood as a constituent unit that transmits and receives data through any form of known wired or wireless communication system. For example, the network unit 130 may perform data transmission and reception using a wired or wireless communication system such as a Local Area Network (LAN), Wideband Code Division Multiple Access (WCDMA), Long Term Evolution (LTE), Wireless Broadband Internet (WIBRO), 5th Generation Mobile Communication (5G), Ultra Wide-Band (UWB) wireless communication, Zigbee, Radio Frequency (RF) communication, Wireless Local Area Network (Wireless LAN), Wireless Fidelity (Wi-Fi), Near Field Communication (NFC), or Bluetooth. Since the communication systems described above are only examples, the wired or wireless communication system for data transmission and reception of the network unit 130 can be variously applied other than the examples described above.

The network unit 130 can receive data necessary for the processor 110 to perform operations, via wired or wireless communication with any system or any client, and the like. Furthermore, the network unit 130 can transmit data generated through the operations of the processor 110, via wired or wireless communication with any system or any client, and the like. The network unit 130 can transmit the output data of the artificial intelligence learning model, and intermediate data and processed data derived during the operation process of the processor 110, via communication with the aforementioned database, server, or computing apparatus, and the like.

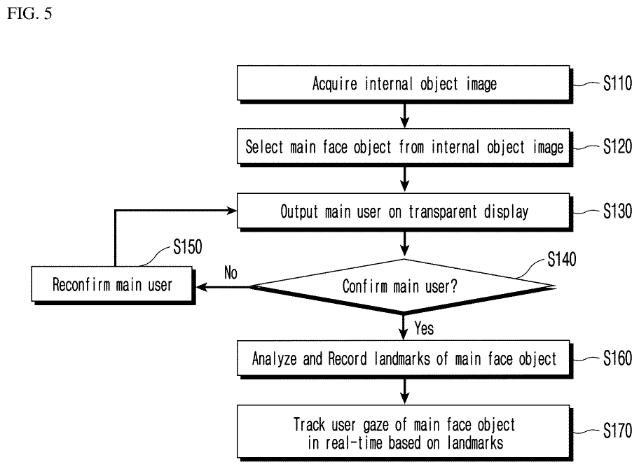

FIG. 5 is a flowchart illustrating the process of selecting a main user in a method of providing augmented content for a transparent display based on the gaze of a mobility occupant according to an embodiment of the present invention.

The method of providing augmented content for a transparent display based on the gaze of a mobility occupant, performed by the computing apparatus 100, obtains an internal object image including the mobility occupant from a first camera module 221 that photographs the interior of the mobility vehicle (S110). If a plurality of seats where an occupant can sit, excluding the driver's seat, are disposed inside the mobility vehicle, the first camera module 221 may be disposed for each seat, its shooting angle may be set in a direction facing the face of the occupant seated in the corresponding seat, and it may be a camera having Pan, Tilt, and Zoom (PTZ) functions or a depth camera.

Even for the same mobility vehicle, since the distance between the seat and the camera module may vary depending on the seat position inside the vehicle, the first camera module 221, which targets the occupant of each seat, may set different reference information for filtering the main user selected as the main face object, specifically, a preset distance from the center of the internal object image and a preset size of the face object. The computing apparatus 100 sets only the user seated in the seat corresponding to each camera module 221 as the main user, and augments the content according to the main user's gaze information.

The computing apparatus 100 detects at least one face object in the internal object image, sets face regions corresponding to the detected face objects, and selects (S120) a face object existing within a preset distance from the center of the internal object image among the set face regions as the main face object.

In the case where a plurality of faces are detected in the internal object image acquired from the first camera module 221, the detected face objects have lower resolution and smaller bounding box sizes for the face region as the distance from the first camera module 221 increases. Therefore, the computing apparatus 100 can filter and select as the main face object only the face object located within a preset distance from the center of the internal object image, that is, the face object located at or below a certain angle relative to the central direction of the first camera module 221. For example, the computing apparatus 100 may use landmarks corresponding to a person's two pupils, the tip of the nose, and the two corners of the mouth to detect only the face objects in the internal object image where all landmarks are marked, and among these, select only the face objects with a preset size or larger as the main face object. If the first camera module 221 is a depth camera, it filters out all but the face objects existing within a certain distance. If a plurality of faces are detected in the internal object image, the computing apparatus 100 can determine the size of the bounding box for each face region and set the face with the largest bounding box as the main face object.

Specifically, when a face region with a bounding box set to include a face object is detected, the computing apparatus 100 measures the size of the bounding box of each face region and estimates the distance between the face object and the first camera module 221 based on an interpolation function, and can generate object location information that estimates the location of the face object based on a first vector derived from the estimated distance between the face object and the first camera module 221, the rotation angle of the first camera module 221, a second vector derived from the center point of the internal object image and the center point of the bounding box, and the location information of the first camera module 221.

Here, the interpolation function interpolates the relationship between the size of the bounding box of each face region and the distance between the bounding box and the face object and the first camera module 221. In the process of selecting the main face object, if one or more occupants are selected as main face objects, the computing apparatus 100 can establish a prioritized user list considering the location and size of the face objects in the internal object image, and perform a main user confirmation process through the transparent display window based on the user list.

The computing apparatus 100 outputs the face object corresponding to the main user having the first priority onto the screen of the transparent display, which has a touch input function (S130), and prompts the user to select ‘Yes/No’ via key input to confirm if the displayed face object is themselves. If the face object currently displayed on the screen is not the main user, the computing apparatus 100 outputs the face object corresponding to the main user having the second priority onto the screen and performs the main user confirmation process (S140, S150).

The computing apparatus 100 records the phase difference of landmarks on the main face object of the main user selected through the main user confirmation process, so that the first camera module 221 can track the main user's gaze information in real-time based on the landmarks (S160, S170).

Here, a landmark may represent a feature point that is representative of each feature of the object within a region of interest. For example, if the region of interest is a face region, the landmark may represent feature points corresponding to the eyes, nose, mouth, and eyebrows, which are features representative of the human face. At least one landmark may be set for each feature of the object, and a plurality of landmarks may also be set for a single feature.

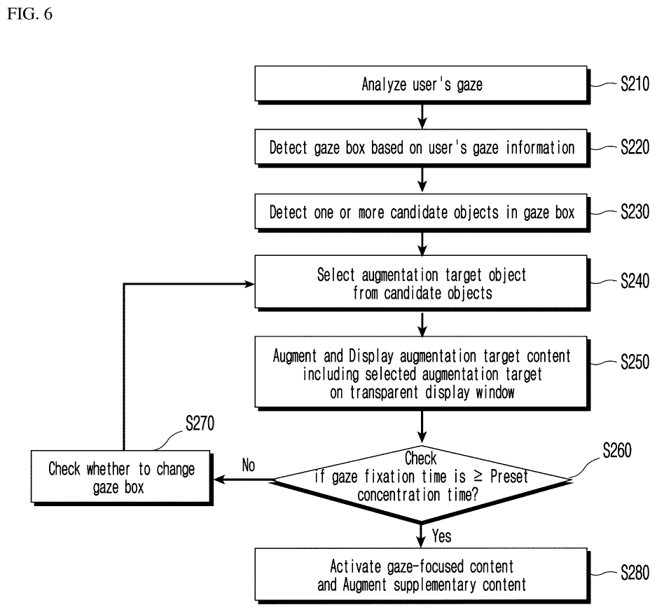

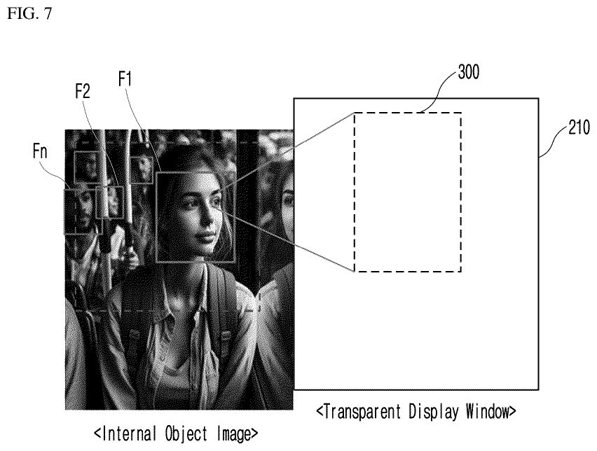

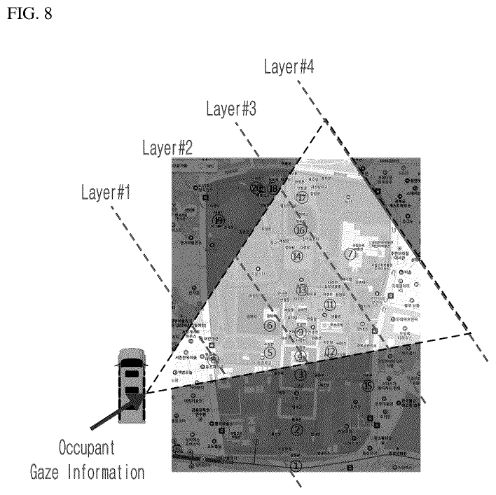

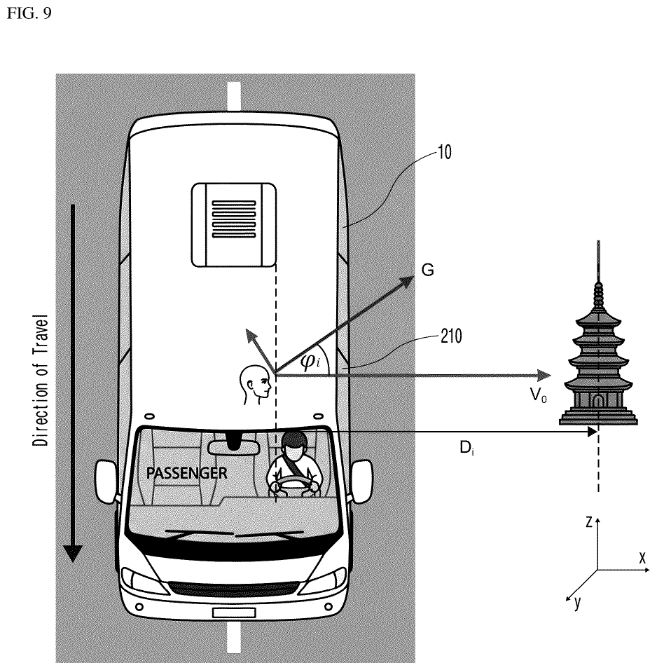

FIG. 6 is a flowchart illustrating a method of providing augmented content for a transparent display based on the gaze of a mobility occupant according to an embodiment of the present invention. FIG. 7 is an exemplary diagram illustrating a gaze box detection process according to an embodiment of the present invention, and FIG. 8 is a diagram illustrating a process of dividing a detected gaze box into a plurality of layers according to an embodiment of the present invention.

The computing apparatus 100 tracks the main user's gaze information in real-time based on the landmarks, and detects and analyzes the face location information and gaze information for the main face object based on the real-time tracked information (S210). As an example, the face location information of the main face object may be seat coordinate information, and the gaze information may include a gaze vector and preset field of view (FOV) information.

As shown in FIG. 7, the computing apparatus 100 tracks the user's gaze directed toward the exterior of the mobility vehicle to detect the user's gaze information, including the gaze vector and field of view (S210), and detects a gaze box 300 based on the user's gaze information (S220).

In this case, the computing apparatus 100 can obtain an exterior object image of the external view of the transparent display window 210 from the second camera module 222, which photographs the exterior of the mobility vehicle, and then detect a plurality of objects existing within the gaze box 300 in the exterior object image. Alternatively, even without using the second camera module 222, the computing apparatus 100 can determine the travel route of the mobility vehicle based on map information and GPS information, and obtain objects existing within the user's gaze box based on the current location of the vehicle and centered around the vehicle's travel route.

Meanwhile, the computing apparatus 100 may integrate the second camera module 222, map information, and GPS information to acquire an external object image and then detect objects existing within the gaze box.

Generally, the field of view (FOV) of a human eye is 60 degrees towards the nose, 90 degrees outwards, 60 degrees upwards, and 60 degrees downwards, based on the normal vector of the left eye (right eye from the perspective of the observer) in the straight-ahead direction. The combined binocular FOV is 180 degrees horizontally and 120 degrees vertically, respectively. However, since the actual functional field of view of a person is approximately 20 degrees to 60 degrees, the computing apparatus 100 may set the field of view to 30 degrees to distinguish between a visible region and a non-visible region, and may set the maximum field of view to 60 degrees.

As shown in FIG. 8, the computing apparatus 100 allows the main user to directly segment the visible distance into a plurality of layers (Layer #1 to Layer #n) based on their gaze information via the transparent display window. Objects including augmentation targets may be displayed in each layer, and when the user touches or selects one of the plurality of layers, the computing apparatus ensures that the augmentation target content and additional content are displayed in more detail in the touched or selected layer compared to other layers.

In this way, the main user can view the external scenery through the transparent display window in detailed layers divided around the augmentation targets according to their gender and age, or they can view the remaining objects or scenery, excluding the augmentation targets, in a simplified manner.

FIG. 9 is a diagram illustrating the augmentation target selection process according to an embodiment of the present invention.

The computing apparatus 100 detects one or more objects existing within the gaze box as candidate objects (S230), and selects (S240) an object that satisfies at least one of the conditions among the field of view condition, the apparent size condition, or the angular velocity condition, from the detected candidate objects, as an augmentation target.

As shown in FIG. 9, the field of view (FOV) condition involves detecting the gaze vector (G) and the object direction vector (Vₒ) for each candidate object, and detecting an object where the angle (φᵢ) between the detected gaze vector and the object direction vector is less than ½ of the maximum field of view (θ_{FOV}), based on the following Equation 1.

$${ϕ}_{i} < \frac{{θ}_{FOV}}{2} \qquad ( Equation 1 )$$

When the above Equation 1 is expressed using the dot product, it can be represented as Equation 2 below.

$$\frac{G \cdot {V}_{o}}{‖ G ‖ ‖ {V}_{o} ‖} > cos ( \frac{{θ}_{FOV}}{2} ) \qquad ( Equation 2 )$$

This field of view condition is for selecting objects existing within the user's current field of view, thereby reducing unnecessary computations and providing only content focused on the user's gaze

The apparent size condition involves detecting an object that is larger than a preset height threshold (Hₜₕ) or a preset area threshold (Wₜₕ), based on the following Equation 3, which uses the actual object height (Hᵢ), the actual object area (Wᵢ) of each candidate object, and the distance (Dᵢ) between the face location information and the candidate object.

$$( \frac{{H}_{i}}{{D}_{i}} > {H}_{th} ) ⋁ ( \frac{{W}_{i}}{{D}_{i}^{2}} > {W}_{th} ) \qquad ( Equation 3 )$$

In this case, the computing apparatus 100 may preset major tourist spots, historical sites, and tourist facilities as candidate objects based on GPS information, and store the established candidate object list, along with size information including the actual object height and object area of each candidate object, in a database in advance. The computing apparatus 100 can perform the task of selecting augmentation targets by only targeting the pre-stored candidate objects, without displaying all objects existing along the travel route of the mobility vehicle based on GPS information.

Meanwhile, if the computing apparatus 100 does not use GPS information, it can use the number of pixels occupied by the candidate object in the vertical direction in the image acquired through the camera module 220 as the object height, and the number of pixels occupied by the candidate object in the horizontal direction as the object area.

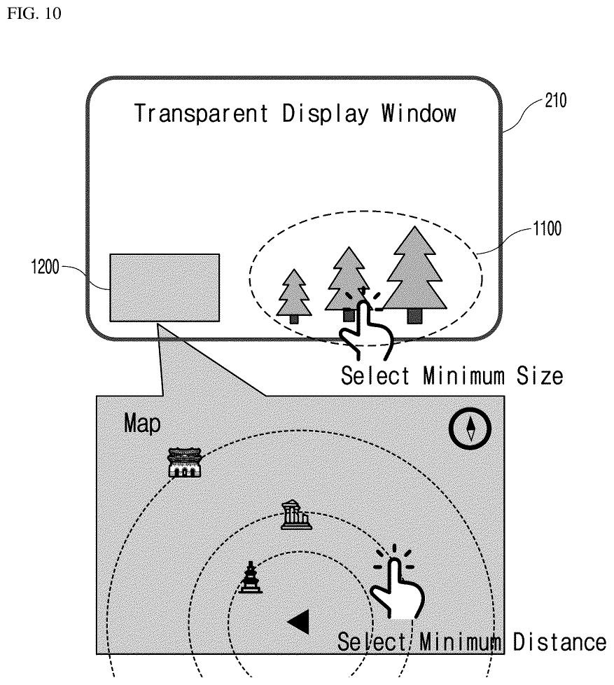

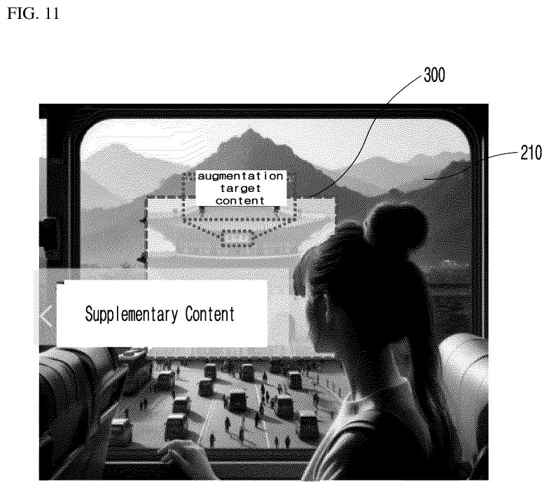

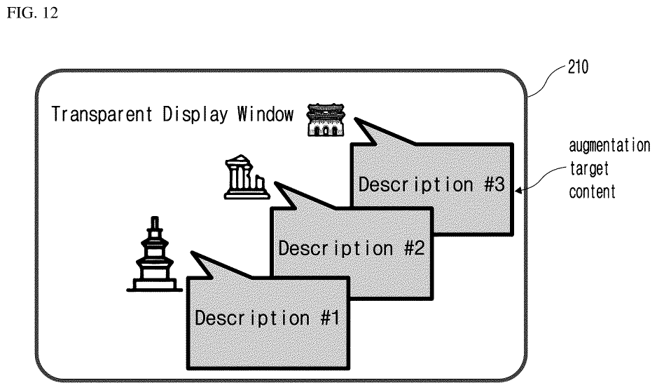

FIG. 10 is an exemplary diagram illustrating the user command input process for selecting an augmentation target on the transparent display window according to an embodiment of the present invention.

As shown in FIG. 10, the computing apparatus 100 can display helper objects 1100 of various sizes on the transparent display window 210, and the user can select, via touch input, the helper object of the minimum size among the helper objects 1100 that they wish to display on the transparent display window 210.

In this case, assuming the distance from the face location information (i.e., the seat coordinate information) to the transparent display window is 60 cm, the helper object can be set to have various sizes in the range of 1 cm² to 5 cm²′ so that the object to be augmented is displayed with a size between 1 cm² to 5 cm². If the user does not select any of the helper objects of various sizes or uses the default setting, the computing apparatus sets the helper object to a size of approximately 2 cm² as the default setting.

Accordingly, the computing apparatus 100 can select only objects larger than the helper object as augmentation targets, based on the minimum size helper object selected by the user. For example, the computing apparatus 100 may set a height threshold or an area threshold based on the minimum size helper object selected by the user.

Furthermore, the computing apparatus 100 may provide a map-linked interface area 1200 on one side of the transparent display window 210 by visualizing a map corresponding to the user's gaze information and candidate objects placed on the map, and the user can easily designate a minimum straight-line distance or a minimum area (or size) for selecting an augmentation target using the map-linked interface area 1200.

This apparent size condition is for determining whether the user can perceive an object at a meaningful size, thereby reducing the rendering load and user fatigue by excluding small objects that are too far away or not clearly visible from being augmentation targets.

The angular velocity condition involves detecting an object for which the angular velocity (ωᵢ) calculated based on the following Equation 4, utilizing the speed of the mobility vehicle (Sᵥ), the distance (Dᵢ) between the face location information and the candidate object, and the angle (θᵢ) between the traveling direction of the mobility vehicle and the candidate object, is smaller than a preset threshold (ωₜₕ).

$${ω}_{i} = \frac{{S}_{v} sin ( {θ}_{i} )}{{D}_{i}} < {ω}_{th} \qquad ( Equation 4 )$$

This angular velocity condition is intended to prevent dizziness in the user when the augmentation target object passes too quickly through their field of view while the mobility vehicle is moving. Therefore, it selects only objects moving below a specific angular velocity, based on the observer (i.e., the main user), to provide stable visual information.

Meanwhile, in another embodiment of the present invention, the augmentation target selection process may involve calculating a field of view score, an apparent size score, and an angular velocity score through the field of view condition, the apparent size condition, and the angular velocity condition, respectively, then calculating an augmentation suitability score by aggregating the calculated field of view score, apparent size score, and angular velocity score, and finally selecting objects whose augmentation suitability score is equal to or greater than a threshold as augmentation targets.

Specifically, the final augmentation suitability score (Score_{A}) for each candidate object (Oi) can be calculated as the weighted product of the field of view score, the apparent size score, and the angular velocity score, as shown in the following Equation 5.

$${Score}_{A} ( {O}_{i} ) = {( {Score}_{FOV} )}^{{w}_{1}} \cdot {( {Score}_{Size} )}^{{w}_{2}} \cdot {( {Score}_{ω} )}^{{w}_{3}} \qquad ( Equation 5 )$$

In Equation 5, w₁, w₂ and w₃ are the weights for the field of view score, the apparent size score, and the angular velocity score, respectively, and the sum of the weights is 1. The computing apparatus 100 may set each weight differently according to the objective. For example, if the goal is to focus more on the user's gaze, the weight for the field of view score (w₁) can be set higher than the other weights.

The Field of View Score (Score_{FOV}) is calculated using the following Equation 6, giving higher scores to objects closer to the center of the user's gaze, thereby emphasizing the object at the point where the gaze is directed.

$${Score}_{FOV} = {e}^{- ( \frac{{ϕ}_{i}^{2}}{2 {σ}^{2}} )} \qquad ( Equation 6 )$$

In Equation 6, φᵢ is the angle between the user's gaze vector and the object direction vector, and a is a coefficient that adjusts the gaze focus range, where a smaller value gives a higher weight to objects directly in the center of the gaze.

The Apparent size score (Score_{Size}) quantifies how large an object appears to the user, is obtained through the following Equation 7, and assigns a low score to small objects that are not visually significant.

The following Equation 7 is based on the apparent height, and uses a sigmoid function to ensure that the score changes smoothly from 0 to 1 based on a specific threshold (Hₜₕ).

$${Score}_{Size} = \frac{1}{1 + {e}^{- k ( \frac{{H}_{i}}{{D}_{i}} - {H}_{th} )}} \qquad ( Equation 7 )$$

“In Equation 7, Hᵢ represents the actual height of object i, Dᵢ represents the distance between the observer and object i, Hₜₕ represents the threshold for size perception, and k represents a coefficient that adjusts the steepness of the score change, respectively.

The Angular Velocity Score (Score_{ω}) is calculated through the following Equation 8, giving a higher score to an object the slower its speed (angular velocity) is as it passes through the field of view while the mobility vehicle is moving, thereby ensuring the user's visual comfort and ease of recognition.

$${Score}_{ω} - \frac{1}{1 + {e}^{m ( {ω}_{i} - {ω}_{th} )}} \qquad ( Equation 8 )$$

In Equation 8, oi represents the angular velocity of object i relative to the user, Sᵥ is the speed of the vehicle, φᵢ is the angle between the vehicle's traveling direction and the object's direction, ωₜₕ is the angular velocity threshold that does not induce dizziness, and m represents a coefficient that adjusts the steepness of the score change.

According to Equation 8, the angular velocity score converges to 1 when the angular velocity (ωᵢ) is much slower than the threshold (ωₜₕ), and the overall angular velocity score converges to 0 when the angular velocity (ωᵢ) is much faster than the threshold (ωₜₕ). Therefore, the slower an object appears and the more comfortable it is for the user, the higher the probability that it will be selected as an augmentation target.

The computing apparatus 100 can finally select only the objects whose calculated final augmentation suitability score (ScoreA) is equal to or greater than a specific threshold (e.g., 0.5) as augmentation targets. Furthermore, if multiple objects are selected as augmentation targets within the main user's same field of view, the computing apparatus 100 can display the augmented content or emphasize it more distinctly in the order of the highest augmentation suitability score.

In this way, when selecting an object to be augmented from among candidate objects, the computing apparatus 100, instead of simply classifying the object as selected or unselected, assigns a score between 0 and 1 according to the field of view condition, the apparent size condition, and the angular velocity condition, calculates a final augmentation suitability score by aggregating all the scores assigned for each condition, and determines that objects with higher augmentation suitability scores are more suitable to display augmented information to the user, thereby selecting them as augmentation targets.

Referring again to FIG. 6, the computing apparatus 100 augments and displays the augmentation target content, which includes the selected augmentation target and supplementary content, on the transparent display window 210, which is positioned in front of the user's gaze based on the face location information (S250). In this case, the computing apparatus 100 can display objects existing in the area outside the gaze box, i.e., objects existing in the non-visible area, in a simplified manner—such as through animation processing, out-of-focus blur, resolution reduction, or extracting only the object's contour information—along with the augmentation target content on the transparent display window.

If movement is detected such that the user's gaze fixation time is less than a preset gaze concentration time, the computing apparatus 100 checks whether to change the gaze box (S260, S270). If the gaze fixation time is equal to or greater than the gaze concentration time, it detects gaze-focused content, including one or more gaze-focused objects located where the user's gaze is concentrated, and activates the gaze-focused content or displays supplementary content along with the augmentation target content (S280).

If the user's gaze fixation time is less than a preset minimum value, the computing apparatus 100 may determine that the user has closed their eyes and can stop the display operation of the augmentation target content. Furthermore, if an electronic shielding device is disposed in front of the transparent display window, the computing apparatus 100 can use the electronic shielding device to shield the transparent display window so as not to disturb the user's sleep or rest.

As an example, if the gaze vector originating from the main user's face location information on the map information is focused on the external scenery, including a specific object, within a preset field of view (e.g., 30 degrees) for the duration of the gaze fixation time, the computing apparatus 100 can set the specific object and its description as a gaze-focused object and display it on the transparent display window either in the form of augmentation target content or as independent content alongside the augmentation target content.

In this case, the gaze-focused content can be displayed with a higher resolution compared to other objects, and various supplementary content, such as text like descriptions or travel route information, or video content related to the gaze-focused object located at the point of concentration, can be interactively added and provided.

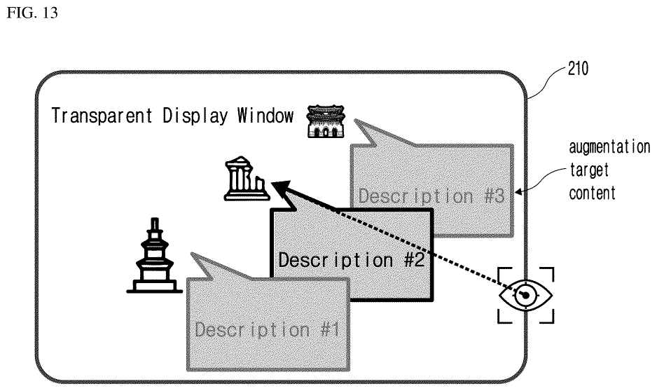

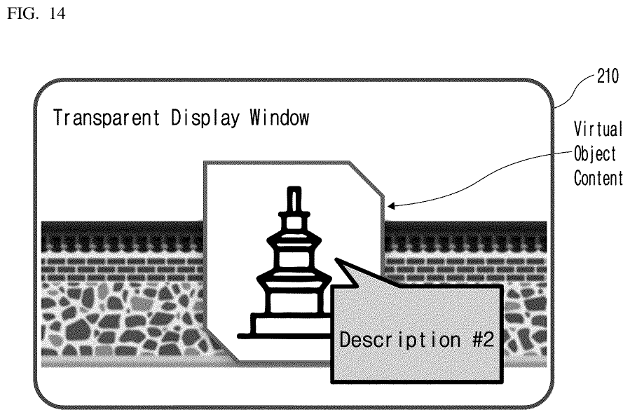

FIG. 12 is an exemplary diagram illustrating the process of displaying augmentation target content based on distance-based priority information according to an embodiment of the present invention, and FIG. 13 is an exemplary diagram illustrating the process of displaying augmentation target content based on gaze-based priority information according to an embodiment of the present invention. Meanwhile, FIG. 14 is an exemplary diagram illustrating the process of overlaying and displaying a virtual object corresponding to an augmentation target according to an embodiment of the present invention.

When multiple objects are selected as augmentation targets in the gaze box, the computing apparatus 100 determines and displays the augmentation priority for the plurality of augmentation targets based on any one of the importance-based priority information, distance-based priority information, or gaze-based priority information.

The computing apparatus 100 sets the importance of preset candidate objects (or landmarks) using a Likert scale in a 5-point or 7-point scale manner. It then confirms the set importance for the selected augmentation targets and ensures that objects (or landmarks) with higher importance are augmented preferentially, or that objects are augmented more distinctly in the descending order of importance.

In this case, the computing apparatus 100 can update the importance score for the augmentation target objects by utilizing the gaze-focused content detection process and employing at least one of the following methods: accumulating the gaze fixation time that the user's gaze remains on each object over a certain period, or counting the frequency with which users' gazes are concentrated on each object.

As shown in FIG. 12, the computing apparatus 100 detects the distance between the main user and the augmentation target object and can augment the content by prioritizing the object located closest to the main user, or by establishing a visual hierarchy where the object's size gradually decreases as it gets further away from the main user, taking the user's gaze path into consideration. In this case, the computing apparatus 100 can set a low transparency (or alpha value) for the augmentation target content corresponding to the object located closest to the main user, allowing that augmentation target content to be displayed more distinctly than other content.

As shown in FIG. 13, the computing apparatus 100 can prioritize the augmentation of the augmentation target that corresponds to the user's gaze vector (or gaze direction) among the plurality of augmentation targets within the user's field of view. Alternatively, it can augment the target corresponding to the user's gaze vector to appear more distinctly than other augmentation targets by emphasizing its silhouette (or contour).

Meanwhile, the tourism mobility vehicle for providing a smart tourism experience can automatically broadcast a tour guide commentary based on the preset viewing path reserved by one or more users or preset viewing path. The computing apparatus 100 can augment, as augmentation target content, an object among the selected augmentation targets that is linked to the tour guide commentary. In this case, the computing apparatus 100 can utilize speech recognition and image recognition functions to extract core keywords (e.g., three-story stone pagoda, etc.) from the tour guide commentary, and augment the augmentation targets corresponding to the extracted core keywords with high priority.

As an example, the computing apparatus 100 recognizes words from the tour guide commentary, and when a core keyword is detected from the recognized words, it can prioritize the augmentation of the image object corresponding to the core keyword. Since the computing apparatus 100 can acquire an image through the camera module 220 and has already selected the objects to be augmented within the acquired image, it can quickly search for the image object corresponding to the core keyword and then prioritize the augmentation of the detected image object.

As shown in FIG. 14, when an object intended for augmentation is occluded by a wall, fence, building, or other structure, the computing apparatus 100 generates a virtual object corresponding to the augmentation target. This generated virtual object is then overlaid onto the transparent display window 210 such that it is placed at the actual object's location, allowing the virtual object content and supplementary content, such as a description of the augmentation target, to be displayed together.

The computing apparatus 100 can confirm the location information of the object to be augmented using the pre-stored candidate object list and the size information of the candidate objects. It can also pre-generate and store virtual objects for objects that are not visible.

Furthermore, even when the external illuminance (ambient light) falls below a certain level, making object identification difficult, the computing apparatus 100 can still show the augmentation target object to the user via the transparent display window by utilizing the virtual object content.

The computing apparatus 100 can detect the external illuminance through the sensor module, and if the brightness contrast between the actual augmentation target object and the augmentation target content is equal to or greater than a threshold based on the detected external illuminance, it can automatically adjust the brightness value of the augmentation target content to suppress glare and improve visibility.

The computing apparatus 100 can display the augmentation target content by setting the transparency or clarity differently for the plurality of augmentation targets within the gaze box, based on at least one of the following pieces of information regarding the objects users are looking at: the frequency of gaze concentration, importance-based priority information, distance-based priority information, or gaze-based priority information.

For example, the computing apparatus 100 ensures that objects with a higher priority or a higher frequency of gaze concentration appear more distinct and clear by using a method such as reducing the brightness by 20% or lowering the transparency by 20% for lower-priority objects compared to higher-priority objects.

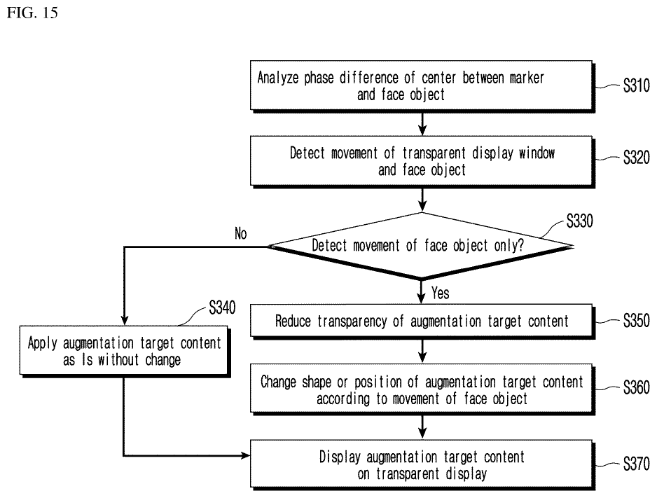

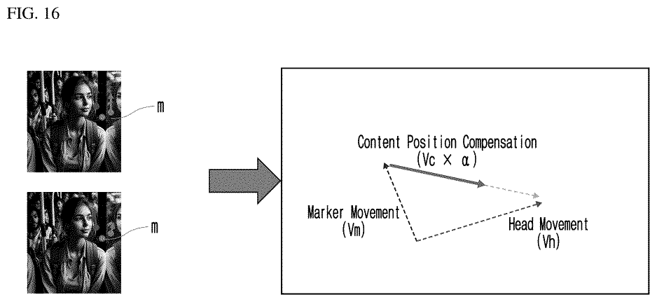

FIG. 15 is a flowchart illustrating the process of optimizing content considering vehicle vibration in a method for providing augmented content for a transparent display based on the gaze of a mobility vehicle occupant, according to an embodiment of the present invention. FIG. 16 is an exemplary diagram illustrating the process of detecting changes in movement between a marker and a facial object according to an embodiment of the present invention.

To detect changes in the movement of the occupant's facial object relative to the augmented content's position on the transparent display window due to mobility vehicle vibration, a marker (m) can be placed on the transparent display window. In this case, the marker (m) may be attached to the outer edge frame of the transparent display window or at a predetermined position within the transparent display window.

In this case, at least two markers (m) may be attached, having different shapes or colors to distinguish between top and bottom, and they are arranged at a pre-designated interval to allow the size and position of the object to be confirmed relative to the markers. Furthermore, the marker (m) may possess luminescent properties for easy distinction even at night. If a camera module (or image sensor) that recognizes objects using an infrared camera or an infrared-based depth camera is used, the marker may be formed of a material with high infrared reflection efficiency. Specifically, the marker (m) can be attached in various shapes such as circular, square, or cross-shaped, using materials like aluminum, or infrared reflective paint/coating. When the marker (m) is attached directly to the transparent display window, it may be formed of a translucent material to transmit external light and avoid becoming significantly darker than the image, ensuring it does not obstruct the occupant's view.

The computing apparatus 100 checks the marker position information in the internal object image and, based on the marker position information, observes the phase change to determine if the facial object, specifically the main face object, is moving with an amplitude and period (phase) equal to or greater than a preset threshold (S310, S320).

The computing apparatus 100 detects whether only the facial object is moving or if the transparent display window is moving along with the facial object (S330). If the computing apparatus 100 determines that the transparent display window is moving along with the facial object, it displays the content on the transparent display window without any changes to the augmentation target content (S340, S370). That is, if the phase change of the face location information relative to the marker position information is constant, the computing apparatus 100 determines that the transparent display window and the occupant are shaking simultaneously and therefore maintains the original form of the augmentation target content.

However, if the computing apparatus 100 determines that the main user's head is moving significantly above the threshold due to vehicle vibration, the augmentation target content may be displayed on the transparent display window at an unintended direction or location, rather than the position corresponding to the gaze box, which can induce dizziness or vertigo in the user.

Therefore, if the main face object does not move in the same direction and magnitude as the transparent display window—that is, if the marker position information (or marker position vector) and the face location information (or facial location vector) change by more than a threshold—the computing apparatus 100 can minimize the dizziness for the main user focusing on the augmentation target content (S350, S360, S370) by reducing the transparency of the augmentation target content below a preset value and changing the shape or position of the augmentation target content according to the movement of the facial object before displaying it on the transparent display window.

Specifically, as shown in FIG. 16, the computing apparatus 100 can minimize dizziness or vertigo by determining a content position compensation value (Vc×α, α<1) based on the phase change value of the face location information (V(h)) and the phase change value of the marker position information (V(m)), and then displaying the position-compensated augmentation target content on the transparent display window.

The computing apparatus 100 synchronizes and stores the vehicle location information, time information, and occupant gaze information using GPS information. As a result, after the mobility vehicle's journey, videos tailored to the individual occupant's gaze information can be clipped and reproduced as personalized videos and provided to the occupant.

Furthermore, the computing apparatus 100 can divide the transparent display into multiple areas and operate each divided area as an independent virtual panel, thereby providing a content augmentation service to multiple occupants using a single transparent display window based on the number of divided areas.

Virtual Reality (VR) technology provides only CG (Computer Graphic) images of real-world objects or backgrounds, whereas Augmented Reality (AR) technology provides a virtually created CG image together with the real-world image of objects. Mixed Reality (MR) technology is a computer graphics technology that mixes and combines virtual objects with the real world. All the aforementioned technologies, including VR, AR, and MR, are sometimes collectively referred to as Extended Reality (XR) technology.

Therefore, the present invention provides augmentation target content on the transparent display window, offering it in the form of Extended Reality (XR) content. This allows for the provision of Mixed Reality (MR) content, which blends Virtual Reality and Augmented Reality, on a single transparent display. Furthermore, if a single transparent display is divided into multiple areas, each divided area can be used to provide different content in the form of Virtual Reality, Augmented Reality, or Extended Reality.

Although FIGS. 5, 6, and 15 describe each step as being executed sequentially, this is merely an exemplary explanation of the technical concept of an embodiment of the present invention. In other words, a person having ordinary skill in the art to which the present invention pertains may modify and vary the order of the steps described in each figure, or execute one or more of the steps in parallel, without departing from the essential characteristics of the present embodiment. Therefore, FIGS. 5, 6, and 15 are not limited to a chronological order.

Meanwhile, the processes shown in FIGS. 5, 6, and 15 can be implemented as computer-readable code on a computer-readable recording medium. The computer-readable recording medium includes all types of recording devices that store data which can be read by a computer system. That is, the computer-readable recording medium includes storage media such as magnetic storage media (e.g., ROM, floppy disk, hard disk, etc.) and optical reading media (e.g., CD-ROM, DVD, etc.). Furthermore, the computer-readable recording medium can be distributed across computer systems connected via a network, allowing the computer-readable code to be stored and executed in a distributed manner.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

What is claimed is:

1. A method for providing augmented content for a transparent display based on a gaze of a mobility occupant, the method being performed by a computing apparatus including at least one processor, the method comprising:
an image acquisition step of acquiring an internal object image, which includes one or more mobility occupants, using a camera module disposed in a mobility vehicle having a transparent display window;
a user setting step of detecting face regions having a bounding box set based on the internal object image, and setting a main user by designating the face region whose bounding box has a size equal to or greater than a preset size as the main face object;
a candidate object detection step of detecting face location information and gaze information centered on the main face object, and detecting candidate objects to be augmented within a user's field of view directed toward an exterior of the mobility vehicle based on the detected gaze information;
an augmentation target selection step of selecting at least one candidate object as an augmentation target that satisfies at least one of the following conditions from among the candidate objects: a field of view condition that detects an object existing within the user's field of view based on the gaze information; an apparent size condition that detects an object larger than a preset threshold based on the face location information and a distance to each candidate object; and an angular velocity condition that detects an object moving at or below a preset reference angular velocity using the face location information and a speed of the mobility vehicle; and
a content augmentation step of augmenting and displaying augmentation target content, which includes the object selected as the augmentation target, on the transparent display window corresponding to the face location information.

2. The method of claim 1, wherein the candidate object detection step comprises: setting landmarks on the main face object; and tracking the gaze information, including a gaze vector and a field of view for the main face object, based on the set landmarks.

3. The method of claim 2, wherein the field of view condition comprises: detecting a gaze vector (G) and object direction vector (Vₒ) of each candidate object, and detecting an object in which an angle (φᵢ) between the detected gaze vector and the object direction vector is less than ½ of the maximum field of view (θ_{FOV}) according to the formula:
$${ϕ}_{i} < \frac{{θ}_{FOV}}{2} .$$

4. The method of claim 1, wherein the apparent size condition comprises: detecting an object larger than a preset height threshold (Hₜₕ) or a preset area threshold (Wₜₕ) based on an actual object height (Hᵢ) of each candidate object, an actual object area (Wᵢ) of each candidate object, and a distance (Dᵢ) between the face location information and the candidate object, according to the formula:
$$( \frac{{H}_{i}}{{D}_{i}} > {H}_{th} ) ⋁ ( \frac{{W}_{i}}{{D}_{i}^{2}} > {W}_{th} ) .$$

5. The method of claim 4, wherein the augmentation target selection step comprises: displaying helper objects of different sizes on the transparent display window; and setting the height threshold or the area threshold based on a size of a selected helper object when one of the helper objects is selected via a user input.

6. The method of claim 1, wherein the angular velocity condition comprises: detecting an object in which an angular velocity (ωᵢ) is less than a preset threshold (ωₜₕ), wherein the angular velocity (ωᵢ) is calculated based on a speed of the mobility vehicle (Sᵥ), a distance (Dᵢ) between the face location information and the candidate object, and an angle (θᵢ) between the mobility vehicle's direction of travel and the object, according to the formula:
$${ω}_{i} = \frac{{S}_{v} sin ( {θ}_{i} )}{{D}_{i}} < {ω}_{th} .$$

7. The method of claim 1, wherein the augmentation target selection step comprises: calculating a field of view score, an apparent size score, and an angular velocity score through the field of view condition, the apparent size condition, and the angular velocity condition, respectively; calculating an augmentation suitability score by integrating the calculated field of view score, apparent size score, and angular velocity score; and selecting as the augmentation targets objects for which the calculated augmentation suitability score is equal to or greater than a preset threshold.

8. The method of claim 7, wherein the augmentation suitability score (Score_{A}) for each candidate object (Oi) is calculated as a weighted product of the field of view score (Score_{FOV}), the apparent size score (Score_{Size}), and the angular velocity score (Score_{ω}) according to the formula:
$${Score}_{A} ( {O}_{i} ) = {( {Score}_{FOV} )}^{{w}_{1}} \cdot {( {Score}_{Size} )}^{{w}_{2}} \cdot {( {Score}_{ω} )}^{{w}_{3}}$$
wherein, in the formula, w₁, w₂, and w₃ are respective weights for the field of view score, the apparent size score, and the angular velocity score, and a sum of the weights is 1.

9. The method of claim 1, wherein the content augmentation step comprises: displaying the augmentation target content, wherein a size of the augmentation target content is warped inversely proportional to a cosine value of an angle formed between a gaze vector within the gaze information and a normal vector of the transparent display window, considering a perspective view.

10. A method for providing augmented content for a transparent display based on a gaze of a mobility occupant, the method being performed by a computing apparatus including at least one processor, the method comprising:
an image acquisition step of acquiring an internal object image, which includes one or more mobility occupants, using a camera module disposed in a mobility vehicle having a transparent display window;
a user setting step of detecting face regions having a bounding box set based on the internal object image, and setting a main user by designating the face region whose bounding box has a size equal to or greater than a preset size as a main face object;
a candidate object detection step of detecting face location information and gaze information centered on the main face object, and detecting candidate objects to be augmented within a user's field of view directed toward an exterior of the mobility vehicle based on the detected gaze information;
an augmentation target selection step of selecting at least one candidate object as an augmentation target that satisfies at least one of: a field of view condition that detects an object existing within the user's field of view based on the gaze information; an apparent size condition that detects an object larger than a preset threshold based on the face location information and a distance to each candidate object; and an angular velocity condition that detects an object moving at or below a preset reference angular velocity using the face location information and a speed of the mobility vehicle;
a content augmentation step of augmenting and displaying augmentation target content, which includes the object selected as the augmentation target, on the transparent display window corresponding to the face location information;
a vibration detection step in which one or more markers are disposed in a preset area of the transparent display window, and a phase change in the face location information is detected based on marker position information for the marker; and
a content compensation step comprising reducing a transparency of the augmentation target content or moving the augmentation target content in a direction of the face based on the face location information, if the face location information fluctuates by more than a preset threshold relative to the marker position information.

11. The method of claim 10, wherein the content compensation step comprises: omitting a content compensation process for the augmentation target content if the face location information fluctuates within the preset threshold relative to the marker position information.

12. A computing apparatus for providing content for a transparent display based on a gaze of a mobility occupant, the computing apparatus comprising:
a processor including at least one core; and
a memory including program codes executable by the processor;
wherein the processor, upon execution of the program codes, is configured to: acquire an internal object image, which includes one or more mobility occupants, using a camera module disposed in a mobility vehicle having a transparent display window; detect face regions having a bounding box set based on the internal object image, and set a main user by designating the face region whose bounding box has a size equal to or greater than a preset size as a main face object; detect face location information and gaze information centered on the main face object, and detect candidate objects to be augmented within a user's field of view directed toward an exterior of the mobility vehicle based on the detected gaze information; select at least one candidate object as an augmentation target that satisfies at least one of: a field of view condition that detects an object existing within the user's field of view based on the gaze information; an apparent size condition that detects an object larger than a preset threshold based on the face location information and a distance to each candidate object; and an angular velocity condition that detects an object moving at or below a preset reference angular velocity using the face location information and a speed of the mobility vehicle; and augment and display augmentation target content, which includes the object selected as the augmentation target, on the transparent display window corresponding to the face location information.

13. A non-transitory computer-readable storage medium storing a computer program, wherein the computer program, when executed by one or more processors, is configured to perform operations for providing content for a transparent display based on a gaze of a mobility occupant, the operations comprising:
an image acquisition operation of acquiring an internal object image, which includes one or more mobility occupants, using a camera module disposed in a mobility vehicle having a transparent display window;
a user setting operation of detecting face regions having a bounding box set based on the internal object image, and setting a main user by designating the face region whose bounding box has a size equal to or greater than a preset size as a main face object;
a candidate object detection operation of detecting face location information and gaze information centered on the main face object, and detecting candidate objects to be augmented within a user's field of view directed toward an exterior of the mobility vehicle based on the detected gaze information;
an augmentation target selection operation of selecting at least one candidate object as an augmentation target that satisfies at least one of: a field of view condition that detects an object existing within the user's field of view based on the gaze information; an apparent size condition that detects an object larger than a preset threshold based on the face location information and a distance to each candidate object; and an angular velocity condition that detects an object moving at or below a preset reference angular velocity using the face location information and a speed of the mobility vehicle; and
a content augmentation operation of augmenting and displaying augmentation target content, which includes the object selected as the augmentation target, on the transparent display window corresponding to the face location information.
